(19) United States
(12) Patent Application Publication
(10) Pub. No.: US 2009/0090047 A1
(43) Pub. Date: Apr. 9, 2009

(54) Additive Useful for Stabilizing Fuel Oils

(75) Inventors: Joseph L. Stark, Richmond, TX (US); Koral B. Johnson, Pasadena, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 12/243,753

(22) Filed: Oct. 1, 2008

Related U.S. Application Data
(60) Provisional application No. 60/977,421, filed on Oct. 4, 2007.

(51) Int. Cl. C10L 1/18; C08G 8/10

(52) U.S. Cl. 44/385; 528/165

(57) ABSTRACT

Fuel oils, especially heavy fuel oils that are subject to instability on storage can be treated with additives in order to stabilizer the fuel oil in regard to precipitating contaminants such as asphaltenes. Alkylphenol resins, either with or without components selected from the group consisting of a fatty acid amides, mannich resins and mixtures thereof are effective additives for stabilizing fuel oils. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims. 37 CFR 1.72(b)

### CROSS REFERENCE TO RELATED APPLICATIONS

This application claims priority from U.S. Provisional Patent Application Ser. No. 60/977,421 which was filed on Oct. 10, 2007 and is fully incorporated herein by reference.

### BACKGROUND OF THE INVENTION

1. Field of the Invention

The present invention relates to fuel additives. The present invention particularly relates to fuel additives useful for stabilizing fuel oils

2. Background of the Art

Historically, fuel oils, also known as heavy fuel oils, have been considered to be those compounds resulting from the refining of crude oil having a vapor pressure at ambient too low to allow for easy combustion. If it could be heated and pumped, it was considered a fuel oil and used in engines that could burn such heavy fuels. Exemplary applications included marine engines, locomotive engines, and use in boilers such as those used for power generation.

More recently, fuel oil may include those coming from other sources, both synthetic and non-synthetic. For example, one synthetic source fuel oil is the so called Fischer-Tropsch fuels. Fischer-Tropsch fuels, also known as FT fuels, include those described as gas-to-liquid (GTL) fuels, biomass-to-liquid (BTL) fuels and coal conversion fuels. To make such fuels, syngas (CO+H(2)) is first generated and then converted to normal paraffins by a Fischer-Tropsch process. The normal paraffins may then be modified by processes such as catalytic cracking/reforming or isomerisation, hydrocracking and hydroisomerisation to yield a variety of hydrocarbons such as iso-paraffins, cyclo-paraffins and aromatic compounds. The resulting FT fuel can be used as such or in combination with other fuel components and fuel types such as those mentioned in this specification.

Even fuels derived from natural sources such as bio-diesels and plant oils may result in the production of at least some heavy fuel oils.

Whatever their source, fuels oils today are the subject of specifications due to the requirements of both governmental regulations and less forgiving apparatus for using the fuel oils. One such regulation is viscosity. For example, ISO 8217 requires that heavy fuel oils have a viscosity of either 180 or 380 cSt at 50° C.

To achieve targeted viscosities, it is the practice of many producers to mix or blend fuel oils having very high viscosities with materials having comparatively low viscosities. While this process is useful for producing fuel oils having the targeted viscosities, fuels produced in such a manner may become unstable and separate out into multiple phases or precipitate solids. It would be desirable in the art to be able to decrease or mitigate such instability.

### SUMMARY OF THE INVENTION

In one aspect, the invention is an additive for stabilizing fuel oils comprising at least a first component which is an alkylphenol resin.

In another aspect, the invention is an additive for stabilizing fuel oils comprising at least a first component which is an alkylphenol resin and further comprising a second component selected from the group consisting of a fatty acid amide, a mannich resin and mixtures thereof.

In still another aspect, the invention is a method for stabilizing fuel oils comprising admixing a fuel oil with an additive useful for stabilizing fuel oils comprising at least a first component which is an alkylphenol resin.

Another aspect of the invention is an admixture of a fuel oil and an additive for stabilizing fuel oils comprising at least a first component which is an alkylphenol resin.

### DESCRIPTION OF THE PREFERRED EMBODIMENTS

In one embodiment, the present invention is an additive useful for stabilizing fuel oils comprising at least a first component which is an alkylphenol resin. The alkyl phenol resins useful as the first component of the additives of the invention include those prepared by reacting an alkyl phenol with an aldehyde. The alkyl phenol may be nonyl phenol but other alkyl phenols may be used. Exemplary alkyl phenols useful for preparing the alkyl phenol resin of the invention include those having the general formula:

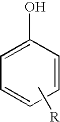

wherein R is an alkyl group having from 4 to 18 carbons.

The alkyl phenol resin may be prepared by reacting the alkyl phenol with an aldehyde. Aldehydes useful for preparing the alkyl phenol resins include formaldehyde, but higher aldehydes may also be used. Higher aldehydes which may be used to prepare the alkyl phenol resins include those aldehydes having from 2 to about 5 carbons.

The alkyl phenol resins may have a molecular weight (M_{w}) of from about three thousand to about twenty five thousand Daltons. In one embodiment, the alkyl phenol resin has a molecular weight of from about four to about twenty thousand Daltons. In still another embodiment, the alkyl phenol resin has a molecular weight of from about five to about ten thousand Daltons. While the structure of the alkyl phenol resins useful with the invention has been described as the reaction product certain starting materials, the alkyl phenol resins may be prepared by any means known to those skilled in art to be useful for preparing such resins.

In another embodiment, the additives of the invention may also include second component selected from the group consisting of fatty acid amides, mannich resins and mixtures thereof. The fatty acid amides useful with the invention include those prepared using a fatty acid having from 8 to about 26 carbons. The amides may be prepared using a hydroxyl alkyl amine such as 2-(2-amino ethylamine)ethanol, diethanolamine, or aminoethyl ethanolamine or other hydroxyl alkyl amine having from about 4 to about 8 carbons. While the structure of the fatty acid amides useful with the invention has been described as the reaction product certain starting materials, the fatty acid amides may be prepared by any means known to those skilled in art to be useful for preparing such resins.

Mannich resins useful with the invention include those which may be prepared using an alkyl phenol, an aldehyde and a polyamine. The alkyl phenols useful in preparing the Mannich resins include those already described above, namely those phenols also having an alkyl group on the aromatic ring having from about 4 to about 8 carbons. For example dodecyl phenol may be used to prepare the Mannich resins useful with the invention.

Similarly the Mannich resins useful with the invention include those made with formaldehyde but may also include those prepared with higher aldehydes. Higher aldehydes which may be used to prepare the Mannich resins include those aldehydes having from 2 to about 5 carbons.

The polyamines useful for preparing the mannich resins include ethylene diamine, but other amines may also be used. Any amine having at lest two amino groups and from 2 to 22 carbons may be used to prepare the Mannich resins.

The Mannich resins may have a molecular weight (M_{w}) of from about three thousand to about twenty five thousand Daltons. In one embodiment, the Mannich resin has a molecular weight of from about four to about twenty thousand Daltons. In still another embodiment, the Mannich resin has a molecular weight of from about five to about ten thousand Daltons. While the structure of the Mannich resins useful with the invention has been described as the reaction product certain starting materials, the Mannich resins may be prepared by any means known to those skilled in art to be useful for preparing such resins.

The invention is, in one embodiment, a method stabilizing fuel oils comprising admixing a fuel oil with an additive useful for stabilizing fuel oils comprising at least a first component which is an alkylphenol resin. The additives are admixed with the fuel oils using any method known by those of ordinary skill in the art to be useful. For example, in one embodiment, the additives are admixed with the fuel oils when the fuel oils are being prepared by admixing oils of varying viscosity to achieve a target viscosity. In another embodiment, the additives are admixed when the fuel oils being subjected to treatment using the additives are being metered into a truck, ship or other vessel.

The actual means of admixing a fuel oil with an additive of the invention may include any apparatus useful for same. Exemplary apparatus include static mixers, blade mixers, stirred vessels, vessels having recycles lines incorporating static or blade mixers and the like. Any apparatus for mixing known to be useful to those of ordinary skill in the art may be used with the method of the invention. Passive admixing may be accomplished where the additives are introduced into a vessel or transfer line or pipeline and admixing is effected by means of turbulence.

The concentration of the additives needed to stabilize a given fuel oil will vary depending upon the properties of the subject fuel oil. For example, a fuel oil prepared with components that are either comparatively close in viscosity or comparatively low in destabilizing contaminants such as asphaltenes will require less additive than a fuel oil that is prepared with components that have a wide range of viscosity or a comparatively high amount of asphaltenes. Still, in at least one embodiment, the method of the invention may be practiced by admixing sufficient additive to achieve a concentration of from 5 to about 3000 ppm (by weight) of additive in the fuel oil being treated. In other embodiments, the concentration is from about 10 to 2000 ppm. In still other embodiments, the concentrations is from about 50 to about 1000 ppm.

The additives of the invention may be used with any fuel oil. The fuel oils which are most likely to need the additives of the invention are those characterized as heavy fuel oils and which are often used as fuel in marine and locomotives. Such heavy oils are often also used for firing boilers for electricity generation or steam generation. ASTM D396-04 references Grades 4-6 with grades 4 ad 5 having subcategorization as being heavy and light. Any of these, but especially Grade 6, which is also known as Bunker C oil, may benefit from the use of the additives of the invention.

### EXAMPLES

The following examples are provided to illustrate the invention. The examples are not intended to limit the scope of the invention and they should not be so interpreted. Amounts are in weight parts or weight percentages unless otherwise indicated.

### Example 1

A fuel oil was prepared by admixing a first oil having the properties listed below with an Ultra Low Sulfur Diesel in a ratio of 86.5:13.5 to prepare a fuel oil having a viscosity of 183 cSt at 50° C. The first oil had an asphaltenes concentration of 8.5%, a sulfur content of 2.65%, an API gravity value of 12.8 and a specific gravity of 0.9806. The Ultra Low Sulfur Diesel had an API gravity value of 33.4 and specific gravity of 0.8581.

The additive is prepared using the components shown in the Table. The alkyl phenol resin is an alkyl phenol resin prepared using nonyl phenol and formaldehyde and has a molecular weight (M_{w}) of 2000 to 5000 g/mole done using a GPC and polystyrene standard. The Mannich resin is prepare using dodecyl phenol, formaldehyde and ethylene diamine. It has a molecular weight similar to that of the alkyl phenol resin. The fatty acid amide is prepared using a C18 fatty acid and aminoethyl ethanol amine. The resultant fuel oil and the additive are admixed and then subjected to an ASIT® test. The results are shown below in Table 1.

### Example 2

The same fuel oil and additive admixture as used in Example 1 is tested using the hot filtration test [ASTM-D4870]. The results are also shown below in Table 1.

TABLE 1

| | | Hot | | | |
|---|---|---|---|---|---|
| | | Filtration | Alkylphenol | Mannich | |
| | ASI | Test | Resin | Resin | Fatty Acid |
| Sample # | Value | (% m/m) | [%] | [%] | Amide [%] |
| 1-1* | 73.3 | 0.0668 | 0 | 0 | 0 |
| 1-2 | 89.7 | NA | 100 | 0 | 0 |
| 1-3 | 101.2 | 0.0465 | 60 | 40 | 0 |
| 1-4 | 101.8 | 0.0555 | 60 | 0 | 40 |
| 1-5* | 77.0 | NA | 0 | 100 | 0 |
| 1-6* | 78.8 | NA | 0 | 0 | 100 |

*Not an example of the invention

Examples 1 and 2 are substantially repeated except that an oil having a viscosity of 380 cSt at 50° C. is used. The results are reported below in Table 2.

TABLE 2

| | | Hot | | | |
|---|---|---|---|---|---|
| | | Filtration | Alkylphenol | Mannich | |
| | ASI | Test | Resin | Resin | Fatty Acid |
| Sample # | Value | (% m/m) | [%] | [%] | Amide [%] |
| 2-1* | 72.2 | 0.0641 | 0 | 0 | 0 |
| 2-2 | 100.0 | 0.0459 | 60 | 40 | 0 |
| 2-3 | 103.6 | 0.0468 | 60 | 0 | 40 |
| 2-4 | 101.2 | 0.0435 | 60 | 20 | 20 |

*Not an example of the invention

### BRIEF DESCRIPTION OF THE EXAMPLES

The Examples illustrate that the alkylphenol resin either with or without a second component is an effective stabilizer for fuel oils.

What is claimed is:

1. An additive for stabilizing fuel oils comprising at least a first component which is an alkylphenol resin.

2. The additive of claim 1 wherein the alkyl phenol resin is prepared using an alkyl phenol having a general formula: 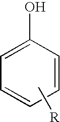
wherein R is an alkyl group having from 4 to 18 carbons.

3. The additive of claim 2 wherein the alkylphenol is reacted with formaldehyde to form the alkylphenol resin.

4. The additive of claim 1 wherein the alkylphenol resin has a molecular weight (M_{w}) of from about 3,000 to about 20,000 Daltons.

5. The additive of claim 1 further comprising a second component selected from the group consisting of a fatty acid amide, a mannich resin and mixtures thereof.

6. The additive of claim 5 wherein the second component is a fatty acid amide having from about 8 to about 26 carbons.

7. The additive of claim 6 wherein the fatty acid amide is prepared using a compound selected from the group consisting of 2-(2-amino ethylamine)ethanol, diethanolamine, aminoethyl ethanolamine and mixtures thereof.

8. The additive of claim 5 wherein the second component is a mannich resin prepared from a formulation including an alkyl phenol, an aldehyde and a polyamine.

9. The additive of claim 8 wherein the alkyl phenol has a general formula: 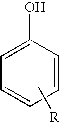
wherein R is an alkyl group having from 4 to 18 carbons.

10. The additive of claim 9 wherein the alkyl phenol is dodecyl phenol.

11. The additive of claim 8 wherein the aldehyde is formaldehyde.

12. The additive of claim 8 wherein the polyamine has from 2 to 22 carbons.

13. The additive of claim 12 wherein the polyamine is ethylene diamine.

14. The additive of claim 5 wherein the second component is a mannich resin having a molecular weight (M_{w}) of from about from about 4,000 to about 20,000 Daltons.

15. A method for stabilizing a fuel oil comprising admixing a fuel oil with an additive for stabilizing a fuel oil comprising at least a first component which is an alkylphenol resin.

16. The method of claim 15 wherein the additive additionally comprises a second component selected from the group consisting of a fatty acid amide, a mannich resin and mixtures thereof.

17. The method of claim 15 wherein the additive is admixed with the fuel oil at a concentration of from about 5 to about 3,000 ppm.

18. The method of claim 17 wherein the additive is admixed with the fuel oil at a concentration of from about 50 to about 1,000 ppm.

19. A composition comprising an admixture of a fuel oil and an additive of claim 1.

20. The composition of claim 19 wherein the fuel oil is a heavy fuel oil.

21. The composition of claim 20 wherein the heavy fuel oil is Bunker C oil.

22. The composition of claim 21 wherein the additive is present at a concentration of from about 10 to about 2,000 ppm.
